(19) United States
(12) Patent Application Publication
(10) Pub. No.: US 2017/0245673 A1
(43) Pub. Date: Aug. 31, 2017

(54) CIRCULATOR APPARATUS

(71) Applicant: PENG FA DESIGN INTERNATIONAL CO. LTD., Hsinchu County (TW)

(72) Inventors: Yen-Chun PENG, Hsinchu County (TW); Yun-Yi TING, Taipei City (TW)

(21) Appl. No.: 15/054,774

(22) Filed: Feb. 26, 2016

(51) Int. Cl. A47J 27/10; A47J 36/00; A47J 27/00

(52) U.S. Cl. CPC A47J 27/10; A47J 27/004; A47J 36/00

(57) ABSTRACT

A circulator apparatus comprises a housing, a processing module, and a display, a heater, and a motor are coupled to the processing module. The motor has a shaft connected to an impeller. The circulator apparatus further comprises a stand, and the stand has a base member, a supporting member, and a mounting member. Two ends of the supporting member are connected the base member and the mounting member respectively, the supporting member is configured to lift the housing, so the bottom side of the housing is located away from the base member by a predetermined distance.

### BACKGROUND OF THE INVENTION

1. Field of the Invention

The present invention is related to a circulator apparatus; in particular, to a circulator apparatus that has a stand and is available to stand firm.

2. Description of Related Art

Sous-vide is a method of cooking food sealed in airtight plastic bags in a water bath for longer than normal cooking times at an accurately regulated temperature much lower than normally used for cooking, typically around 55° C. (131° F.) to 60° C. (140° F.) for meats and higher for vegetables. Current sous-vide circulators tend to be designed like scientific equipment consisting of an AC motor above the water and shaft attached to a submersed impeller that agitates or pumps the water.

Current commercial sous-vide circulators have some drawbacks as follows:

1. The current commercial sous-vide circulator has a clip arranged on the housing and configured to support the housing on a wall of the pot. However, the circulator may fall into the pot due to the vibration, and it would be dangerous when the electronic components immerse in the fluid.

2. The current circulator is not suited for a pot with declining rim.

3. The weight of current circulator is about 1.5˜3 kg, and a pot with a thin rim cannot support the current circulator.

4. The current circulator is not suited for a pot with a special shape.

5. The current circulator is not suited for a pot with a short rim.

### SUMMARY OF THE INVENTION

The object of the instant disclosure is to provide a circulator apparatus that is suited for all kinds of pots.

In order to overcome the above mentioned problem, the circulator of the present invention includes a housing, and the housing comprises an upper casing and a lower casing. A plurality of fluid holes are disposed in the lower casing, so the liquid can flow in or out from the lower casing. The processing module includes a printed circuit board disposed inside the upper casing. The display module is installed on the top side of the upper casing and electrically connected to the processing module. The display module with touch function is configured to display information.

The motor is disposed inside the upper casing and electrically connected the processing module. A shaft is provided at the lower casing, and one end of the shaft is connected to the motor and another end of the shaft is connected to an impeller. The motor is configured to rotate the impeller through the shaft. A heater is located in the lower casing and electrically connected the processing module. The heater is configured to heat the fluid.

A sensing module is disposed inside the housing and has a first sensor, a second sensor, and a third sensor. The first sensor is disposed in the lower casing and configured to measure height and temperature of the fluid. The second sensor is disposed in the lower casing and configured to measure the height and temperature of the fluid.

The third sensor is disposed inside the lower casing and configured to measure the height and temperature of the fluid. The measuring position of the first sensor is lower than the measuring position of the second sensor. The measure position of the second sensor is lower than the measure position of the third sensor.

A stand comprises a base member, a supporting member, and a mounting member. Two ends of the supporting member are connected the base member and the mounting member respectively. The supporting member is configured to lift the housing, so the bottom end of the housing is located away from the base member by a predetermined distance.

The instant disclosure has the advantages that the housing is lifted by the stand, so bottom end of the housing is located away from a pot by a predetermined distance.

The pot is put onto the base member of the stand, and the pot stands firm because the stand bears the whole weight of the pot. The base member of the stand connects the supporting member and the mounting member respectively. The housing is disposed in the mounting member, and the pot is put on the base member of the stand, so the housing stands firmly and prevents the housing detaching from the stand and falling into the pot. The circulator apparatus of the present invention is suited for all kinds of pots, for instance, pots with declining rim, thin rim, shorter rim, or where the rim of the pot has varied shapes.

In order to further appreciate the characteristics and technical contents of the present invention, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a perspective view of a circulator apparatus in the instant disclosure;

FIG. 2 shows a first schematic representation of the circulator apparatus in the instant disclosure;

FIG. 3 shows a second schematic representation of the circulator apparatus in the instant disclosure;

FIG. 4 shows a third schematic representation of the circulator apparatus in the instant disclosure;

FIG. 5A shows a fourth schematic representation of the circulator apparatus in the instant disclosure;

FIG. 5B shows a fifth schematic representation of the circulator apparatus in the instant disclosure;

FIG. 6 shows a first exploded view of the circulator apparatus in the instant disclosure;

FIG. 7 shows a second exploded view of the circulator apparatus in the instant disclosure;

FIG. 8 shows a first detail view of the circulator apparatus in the instant disclosure;

FIG. 9 shows a second detail view of the circulator apparatus in the instant disclosure; and

FIG. 10 shows a third detail view of the circulator apparatus in the instant disclosure.

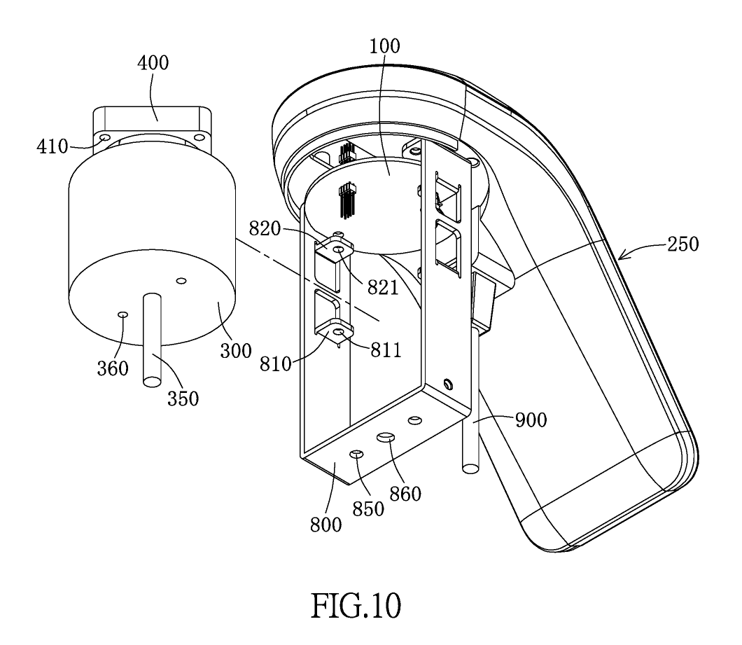

### DETAILED DESCRIPTION OF THE PREFERRED EMBODIMENTS

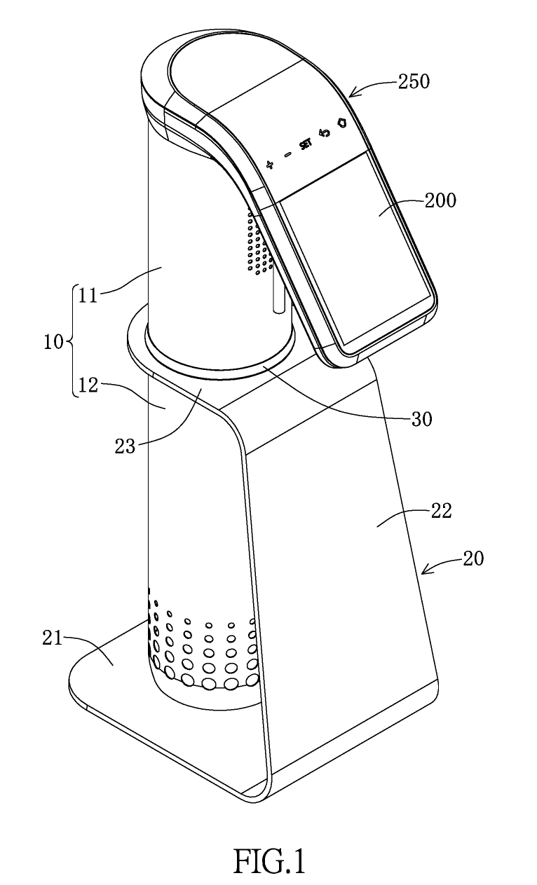

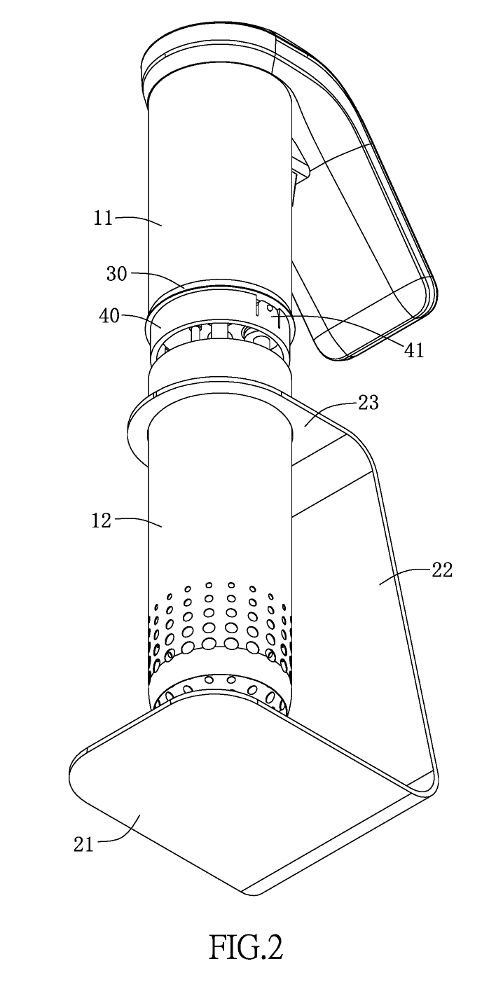

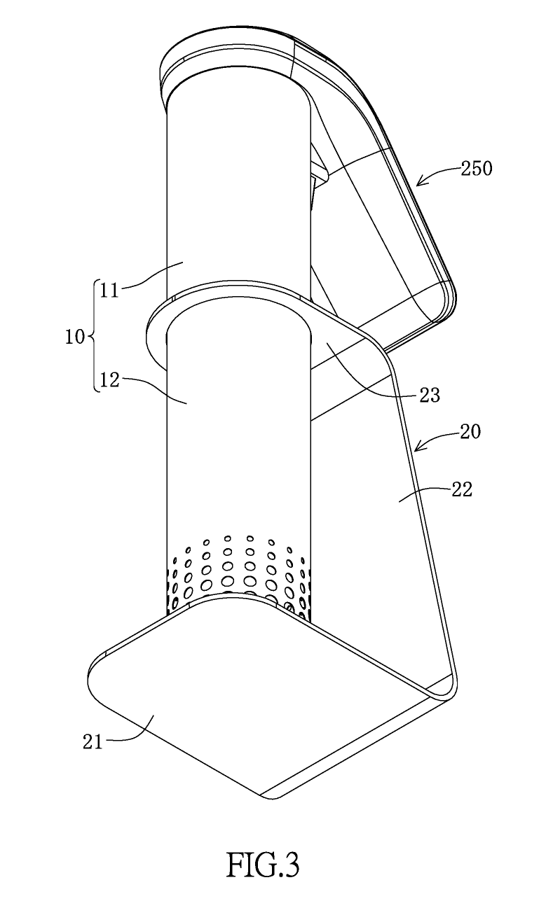

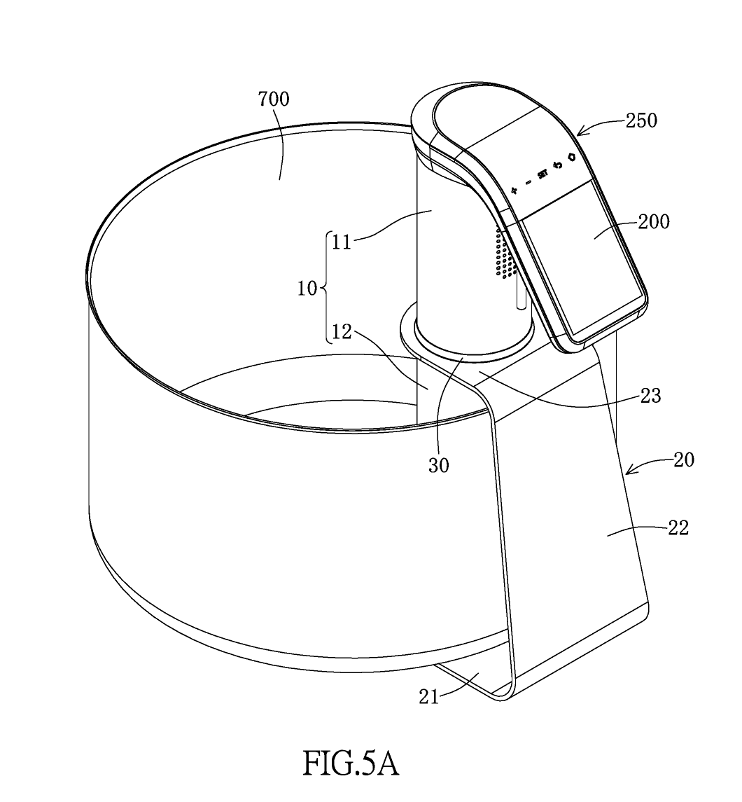

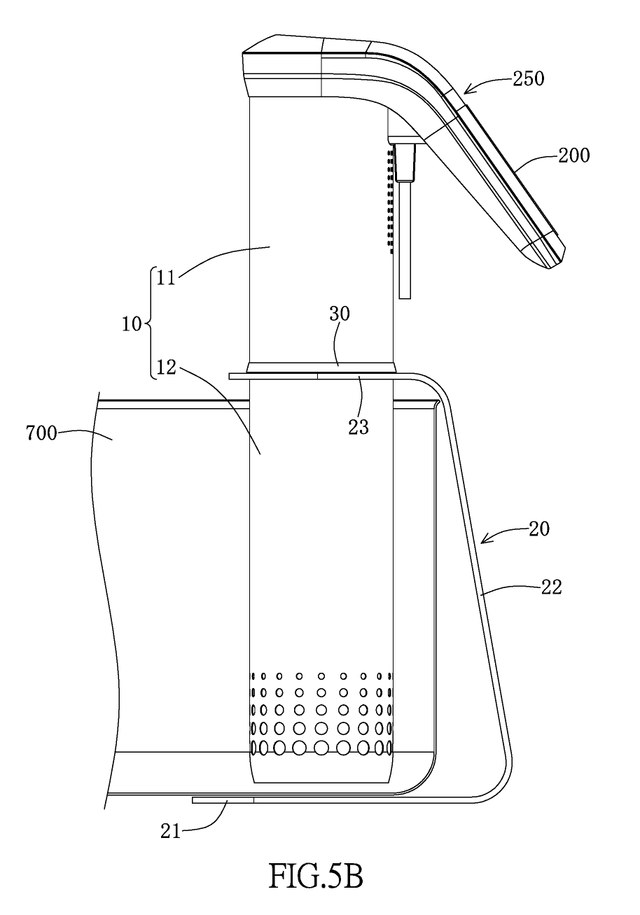

Please refer to FIGS. 1, 2, 3, 6, and 7. The circulator apparatus according to the present invention includes a housing 10 and processing module 100. The processing module 100 has a printed circuit board and a plurality of electronic components installed on the printed circuit board. A display module 200 and a motor 300 are coupled to the processing module 100. The motor 300 is connected to the impeller 320 by the shaft 310, and the heater 500 is connected to the processing module 100. The circulator apparatus of the present invention comprises a stand 20, and the stand 20 includes a base member 21, a supporting member 22, and a mounting member 23. Two ends of the supporting member 22 are connected the base member 21 and mounting member 23 respectively. As shown in FIGS. 5A and 5B, the supporting member 22 of the stand 20 is configured to lift the housing 10 so the bottom end of the housing 10 is located away from the base member 21 by a predetermined distance.

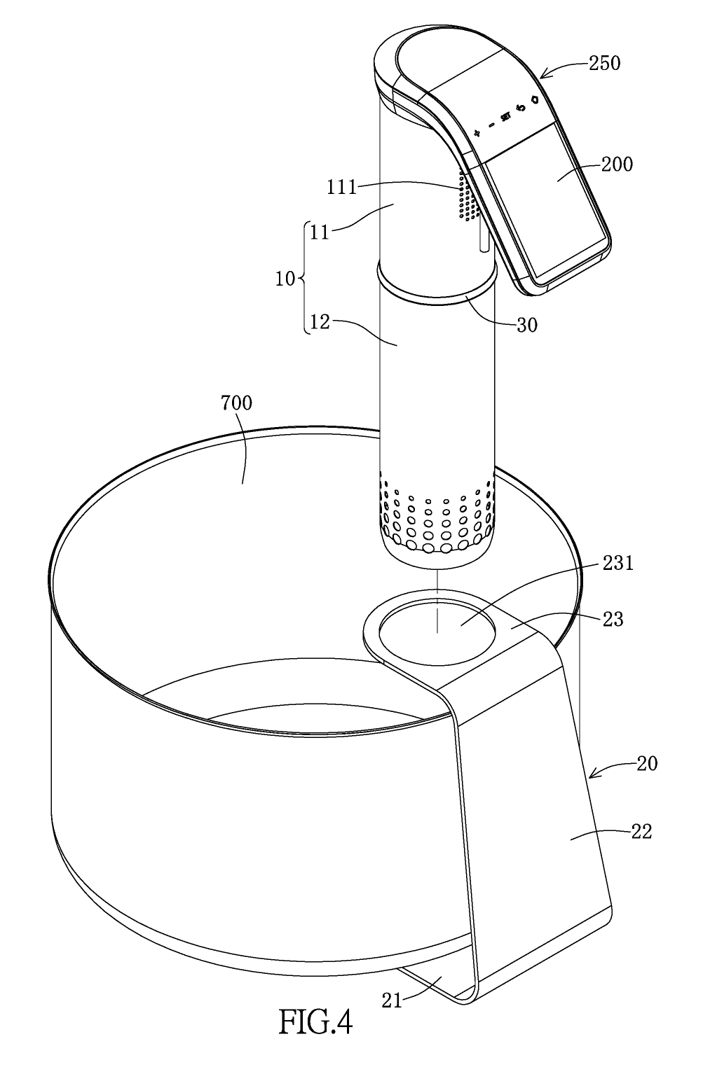

Please refer to FIG. 4. In this embodiment, the mounting member 23 has a cavity 231 for the housing 10 to penetrate through. A stop ring 30 is disposed in the housing 10, and the mounting member 23 is abutted against bottom side of the stop ring 30. The housing 10 further comprises an upper casing 11 and a lower casing 12, and the stop ring 30 is located between the upper casing 11 and the lower casing 12.

In this embodiment, the circulator apparatus of the present invention further comprises a control portion 250 extended downward from the top end of the housing 10. The display 200 is disposed in the control portion 250 for displaying information and can be operated by a user.

A base 40 is installed inside the housing 10 and located between the upper casing 11 and lower casing 12. Both sides of the base 40 are formed with two clips 41 corresponding to the inner wall of the lower casing 12. More specifically, the clip 41 is a kind of a resilient element with a protrusion, and the clip 41 can deform inward and the protrusion abuts the inner wall of the lower casing 12. The friction force between the protrusion and the inner wall of the lower casing 12 prevents the lower casing 12 from being detached from the base 40. The stop ring 30 may be, but is not limited to, formed in the base 40, or integrates with housing 10. The position where the stop ring 30 disposed is not limited.

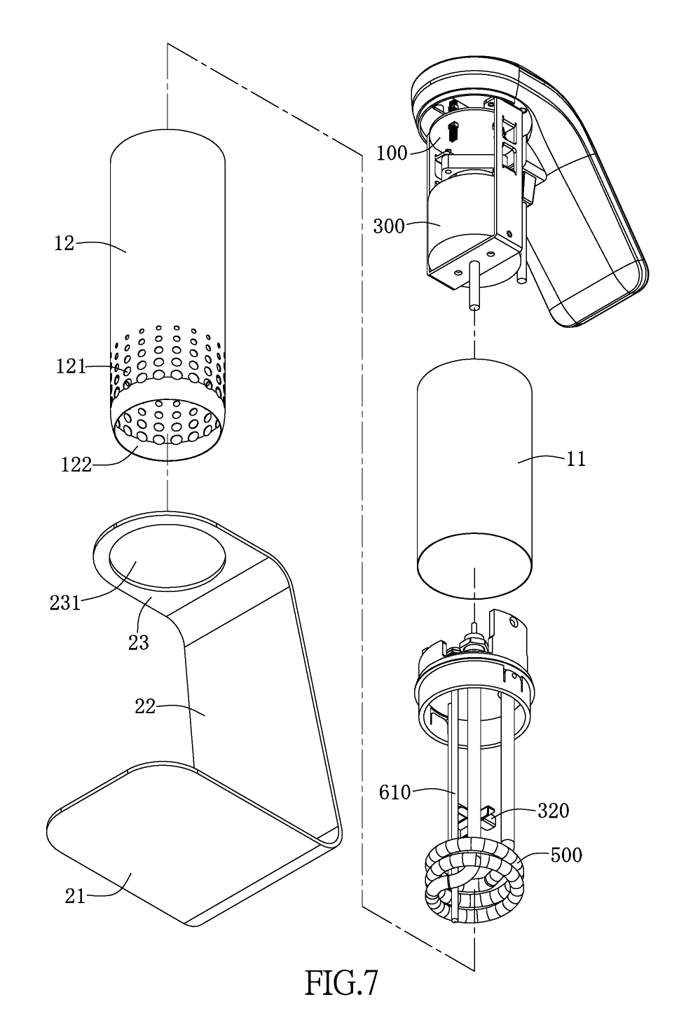

Please refer to FIG. 7. A plurality of fluid holes 121 are formed around the lower casing 12, and an opening 122 is formed in bottom end of the lower casing 12. The fluid flows into or out of the lower casing 12 of the housing 10 through the fluid holes 121 and the opening 122. The diameter of the fluid holes 121 varies, more specifically, the fluid holes 121 adjacent the bottom end of the lower casing 12 are bigger than the fluid holes 121 located away from the bottom end of the lower casing 12, so the velocity of flow varies accordingly. The fluid through the bigger fluid holes 121 flows faster than the fluid through the smaller fluid holes 121.

Please refer to FIGS. 4, 5A, and 5B. A pot 700 is put onto the base member 21 of the stand 20, and the housing 10 penetrates though the cavity 231 of the mounting member 23 from the top side of the stand 20. The bottom side of the stop ring 30 abuts against the top side of the mounting member 23 of the stand 20. The stop ring 30 and the mounting member 23 are configured to limit the downside movement of the housing 10. The supporting member 22 of the stand 20 is configured to lift the housing 10 so the bottom end of the housing 10 is located away from the base member 21 by a predetermined distance. More specifically, the mounting member 23 is located above the base member 21 by means of the supporting member 22, and the mounting member 23 keeps the base member 21 at a predetermined distance. When the housing 10 installs in the stand 20, the mounting member 23 abuts against the stop ring 30 of the housing 10, so there is a height difference between the housing 10 and the pot 700. That is to say, the stand 20 lifts the housing 10, so the bottom end of the housing 10 is located away from bottom side of the pot 700 by a predetermined distance.

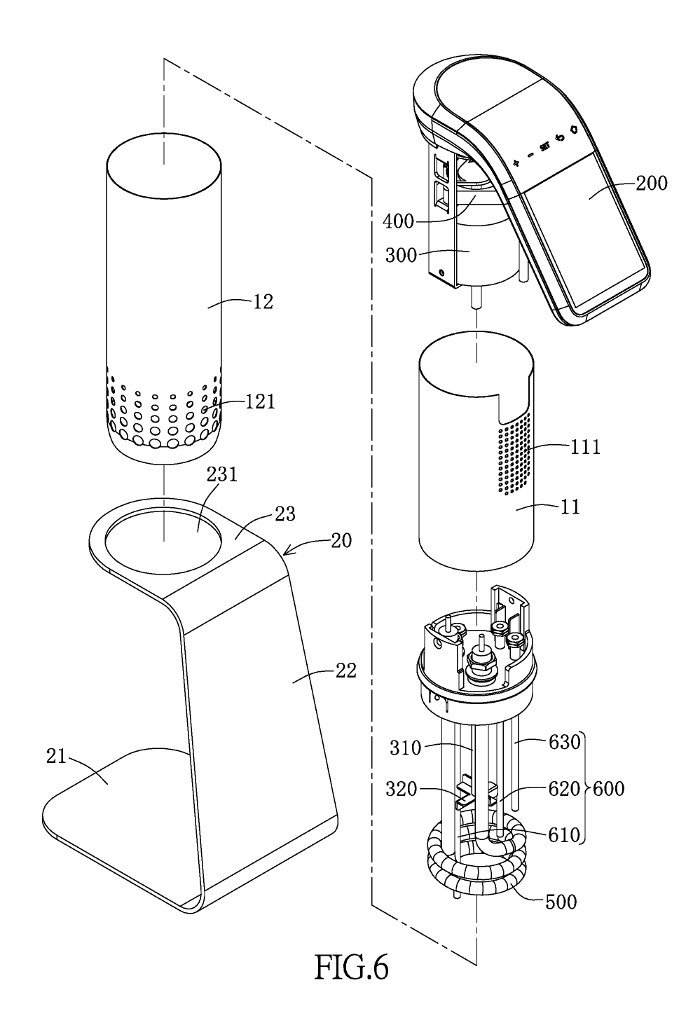

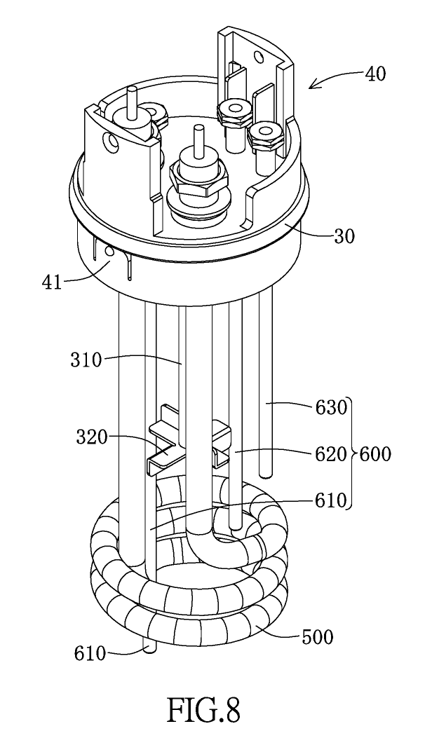

Please refer to FIGS. 6 to 8. The circulator apparatus according to the present invention further comprises a fan 400 installed on the top side of the motor 300, and the fan 400 is disposed inside the upper casing 11. A plurality of vent holes 111 is formed on the upper casing 11 corresponding to the fan 400. The fan 400 is configured to dissipate the heat from the motor 300, and the hot air is released through the vent holes 111. The shaft 310 of the motor 300 connects an impeller 320. The motor 300 turns the impeller 320 by the shaft 310. A heater 500 is disposed inside the lower casing 12 of the housing 10 and outputs thermal energy to heat the fluid.

As shown in FIGS. 6 to 8, a sensing module 600 is installed inside the housing 10. The sensing module 600 is located inside the lower casing 12 of the housing 10, and is substantially parallel to the shaft 310 of the motor 300. The sensing module 600 is configured to measure the height and temperature of the fluid. The sensing module 600 includes a first sensor 610, a second sensor 620, and a third sensor 630. The measuring position of the first sensor 610 is lower than the measuring position of the second sensor 620, and the measuring position of the second sensor 620 is lower than the measuring position of the third sensor 630.

The first sensor 610 is configured to measure the height and temperature of the fluid adjacent to the bottom side of the pot 700. The heater 500 stops heating the fluid for safety if the first sensor 610 cannot measure any fluid level so as to prevent damage. The second sensor 620 is installed adjacent to the heater 500 and is configured to measure height and temperature of the fluid adjacent to the heater 500. The third sensor 630 is located higher than the first sensor 610 and the second sensor 620. The third sensor 630 is configured to measure the top level of the fluid. The circulator apparatus of the present invention controls the heater 500 according to signals transmitted from the first sensor 610, second sensor 620, and third sensor 630.

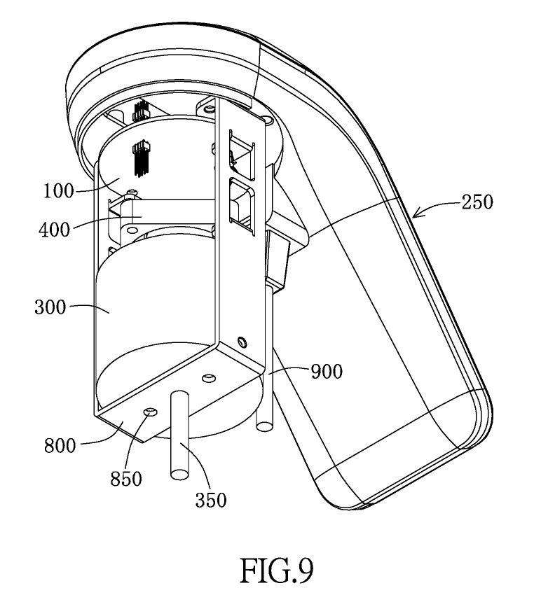

As shown in FIG. 9, the circulator apparatus according to the present invention further comprises a plug 900 and a frame 800. The plug 900 is connected to an external wire and drains energy. The motor 300 and fan 400 are installed in the frame 800 and disposed inside the upper casing 11. More specifically, the frame 800 has a first plate 810 formed on it, and the motor 300 is installed in the first plate 810. The first plate 810 has a locating hole 811 formed in it, and the bottom side of the frame 800 has a locating hole 850 and an axle hole 860. The axle 350 of the motor 300 penetrates through the axle hole 860 and extends outward. A screw (not shown) penetrates through the locating hole 850 and screws into a threaded hole 360 of the motor 300, so the motor 300 is fixed to the frame 800. Moreover, the frame 800 may integrate with the housing 10.

The frame 800 further comprises a second plate 820, and the fan 400 is disposed in the second plate 820. The second plate 820 has a locating hole 821 formed in it, and the fan 400 has a location hole 410 corresponding to the locating hole 821. A screw (not shown) penetrates through the locating hole 821 of the second plate 820 and screws into the location hole 410, so the fan 400 is fixed to the frame 800.

The instant disclosure has the following advantages.

The circulator apparatus in the present invention has a stand configured to lift the housing, so the bottom side of the housing is located away from the bottom side of the pot by a predetermined distance. The conventional circulator has a clamp and is configured to support the circulator on a wall of the pot, so the circulator can fall into the pot easily because of vibration, and the electronic components disposed inside the conventional circulator are damaged accordingly. Moreover, a current circulator is not suited for a pot with a declining rim, thin rim, shorter ring, or where the rim of the pot has a varied shape.

The circulator apparatus according to the present invention, wherein the pot is put onto the base member of the stand, has the stand bear the whole weight of the pot. The base member of the stand connects the supporting member and the mounting member. The housing is disposed in the mounting member, and the pot is put on the base member of the stand, so the housing stands firm and prevents the housing detaching from the stand and falling into the pot. The circulator apparatus of the present invention is suited for all kinds of pots, for instance, the pot with a declining rim, thin rim, shorter rim, or the rim of pot has varied shapes.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A circulator apparatus, comprising:
a housing;
a processing module disposed within the housing, and the processing unit including a printed circuit board;
a display module disposed in top side of the housing and electrically connected the processing module, the display module configured to display information;
a heater disposed within the housing and coupled to the processing unit and configured to heat a liquid;
a sensing module disposed within the housing, and the sensing module coupled to the processing module and configured to measure a height of the liquid and a temperature of the liquid; and
a stand including a base member, a supporting member, and a mounting member, two ends of the supporting member connected the base member and the mounting member respectively, and the supporting member of the stand configured to lift the housing away from the base member by a predetermined distance.

2. The circulator apparatus according to claim 1, wherein the mounting member is parallel to the base member, and the mounting member has a cavity configured to be penetrated by the housing, and the housing has a stop ring, and the stop ring is extended outward from the housing, and the mounting member is abutted against the bottom side of the stop ring.

3. The circulator apparatus according to claim 2, wherein the stop ring is fabricated on the housing as one whole body.

4. The circulator apparatus according to claim 2, wherein the stop ring is formed in a base, and the base is disposed inside the housing.

5. The circulator apparatus according to claim 1, wherein further comprising a frame disposed inside the housing, wherein the frame and is formed with a first plate, and the motor is disposed in the first plate.

6. The circulator apparatus according to claim 5, wherein the frame is formed with a second plate, and a fan is disposed in the second plate.

7. The circulator apparatus according to claim 1, further comprising:
a motor disposed within the housing and coupled to the processing module; and
a shaft disposed within the housing, and one end of the shaft connected to the motor and another end of the shaft connected to an impeller, and the motor turns the shaft and the impeller is rotated.

8. The circulator apparatus according to claim 1, wherein the housing is formed with a plurality of vent holes corresponding to a fan disposed in the housing.

9. The circulator apparatus according to claim 1, wherein the housing includes an upper casing and a lower casing, and a plurality of fluid holes are formed around the lower casing.

10. The circulator apparatus according to claim 9, wherein the sensing module has a first sensor, a second sensor, and a third sensor, and the first sensor, the second sensor, and the third sensor are electrically connected the processing module and disposed in the lower casing, wherein the measuring position of the first sensor is lower than the measuring position of the second sensor, and the measuring position of the second sensor is lower than the measuring position of the third sensor.
